(19) United States
(12) Patent Application Publication
(10) Pub. No.: US 2015/0217594 A1
(43) Pub. Date: Aug. 6, 2015

(54) METHOD FOR PRODUCING MAGNETICALLY INDUCED PATTERNS IN A LAYER DEPOSITED ON A GLASS SHEET

(71) Applicant: AGC GLASS EUROPE, Louvain-La-Neuve (BE)

(72) Inventors: Ronny Pieters, Bruxelles (BE); Dominique Lemal, Moustier-Sur Sambre (BE)

(73) Assignee: AGC GLASS EUROPE, Louvain-La-Neuve (BE)

(21) Appl. No.: 14/413,482

(22) PCT Filed: Jul. 8, 2013
(86) PCT No.: PCT/EP2013/064356

§ 371 Date: Apr. 10, 2015

(30) Foreign Application Priority Data
Jul. 10, 2012 (BE) BE 2012/0482

(51) Int. Cl. B44C 5/04; C03C 23/00; C03C 3/087; C03C 17/00

(52) U.S. Cl. CPC B44C 5/0407; C03C 17/002; C03C 23/00; C03C 3/087

(57) ABSTRACT

The invention relates to a method for producing magnetically induced patterns in a layer deposited on a glass sheet, said method comprising the following steps in succession, as said glass sheet runs over a horizontal roller conveyor in a direction perpendicular to the largest dimension of the rollers of said roller conveyor: (i) depositing, in the form of a layer, a liquid composition on that face of the glass sheet which is opposite the face resting on the conveyor, the composition comprising magnetically orientable particles; (ii) selectively exposing the glass sheet comprising the layer of liquid composition to a magnetic field; and (iii) hardening the liquid composition. According to the invention, the step of selective exposure to a magnetic field is carried out by means of at least one roller of the conveyor comprising at least one element made of a permanently magnetic material integrated into its surface, so as to produce magnetic field lines in a region of the sheet running over the conveyor.

### 1. FIELD OF THE INVENTION

The present invention relates to a method for producing patterns that produce an illusion of relief, or a three-dimensional illusion, or else an illusion of thickness, in a layer deposited on a glass sheet. In particular, the present invention relates to a method for producing magnetically induced patterns in a layer deposited on a glass sheet.

The method of the invention exhibits in particular applications in the field of decoration as the glass sheets which it makes it possible to manufacture exhibit decorative patterns.

### 2. SOLUTIONS OF THE PRIOR ART

Several methods for manufacturing rigid or flexible flat substrates or sheets comprising magnetically induced patterns are already known. Most of these methods use the following successive main steps:
depositing a liquid composition, comprising magnetizable or magnetically orientable particles, in the form of a layer on the substrate;
selective magnetization of said particles while the composition is still fluid and while the particles are therefore still mobile within this layer, bringing about their orientation along the lines of the magnetic field applied and the creation of patterns; and
drying, curing and/or crosslinking of the composition in order to set the particles and therefore fix the patterns created in the layer.

In the methods already described, the method of magnetization/magnetic induction varies. In U.S. Pat. No. 3,676,273, patterns are created in a layer (of acrylic paint for example) comprising magnetizable pigments that is deposited on a substrate (an aluminum panel for example), by interposing, between the magnets (that generate the magnetic field) and the covered substrate, a steel sheet in which said patterns are cut out. However, this technique, which uses the mask principle to selectively apply the magnetic field, has many disadvantages. In particular, the existence of this steel mask does not allow the use of this process for large substrate surfaces and also does not allow the in-line integration thereof (in a production line for example) or a good reproducibility of the patterns. In patent BE 774930, the magnetic induction is obtained owing to a “primer” layer containing particles having permanent magnetization, which layer is dried and magnetized according to the desired pattern. If a liquid layer containing magnetizable particles is deposited on this primer layer, the pattern then appears. However, this technique requires more steps and in particular the deposition and drying of two separate layers.

### 3. OBJECTIVES OF THE INVENTION

An objective of the invention is in particular to overcome these disadvantages of the prior art.

In particular, one objective of the invention is to provide a method for producing magnetically induced patterns in a layer deposited on a glass sheet, which may be used for large glass sheet surfaces and that allows good reproducibility of the patterns.

Another objective of the invention, in at least one of its embodiments, is to provide a method for producing magnetically induced patterns in a layer deposited on a glass sheet, which may be carried out in-line. In particular, one objective of the invention is to provide a method for producing magnetically induced patterns in a layer deposited on a glass sheet, which may be carried out easily and rapidly in an existing painted glass sheet production line and which also makes it possible, once used in said production line, to go back to the initial production line rapidly and easily.

Finally, the invention, in at least one of its embodiments, also has the objective of providing a method for producing magnetically induced patterns in a layer deposited on a glass sheet, which is rapid, economical and comprises a minimum number of steps.

### 4. SUMMARY OF THE INVENTION

In accordance with one particular embodiment, the invention relates to a method for producing magnetically induced patterns in a layer deposited on a glass sheet, said method comprising the following successive steps:
1) depositing a liquid composition in the form of a layer on at least one portion of one of the faces of the glass sheet, said composition comprising magnetically orientable particles;

2) selectively exposing the glass sheet comprising the layer of liquid composition to a magnetic field during which said glass sheet travels on a horizontal roller conveyor, in a direction perpendicular to the largest dimension of said rollers, the liquid composition being on the face opposite that resting on the conveyor; and
3) curing the liquid composition;
   the step 2) of selective exposure to a magnetic field being carried out by means of at least one roller of said conveyor comprising at least one element made of a material having permanent magnetization incorporated into the surface thereof, so as to produce magnetic field lines in the vicinity of the sheet traveling on the conveyor.

Thus, the invention is based on a novel and inventive approach as it makes it possible to solve the abovementioned disadvantages of the prior art and to resolve the technical problem addressed. Specifically, the inventors have demonstrated that it was possible, owing to a modification of a roller of a conveyor within an existing painted glass sheet production line, to obtain a method for producing one or more magnetically induced patterns in a layer deposited on a glass sheet, which may be applied to large glass surfaces, which is reproducible and which may be carried out readily and easily in-line and with a minimum number of steps (in particular only one layer is needed).

Other characteristics and advantages of the invention will become more clearly apparent on reading the following description of a preferred embodiment, given as simple illustrative and nonlimiting example, and the appended figures, among which:

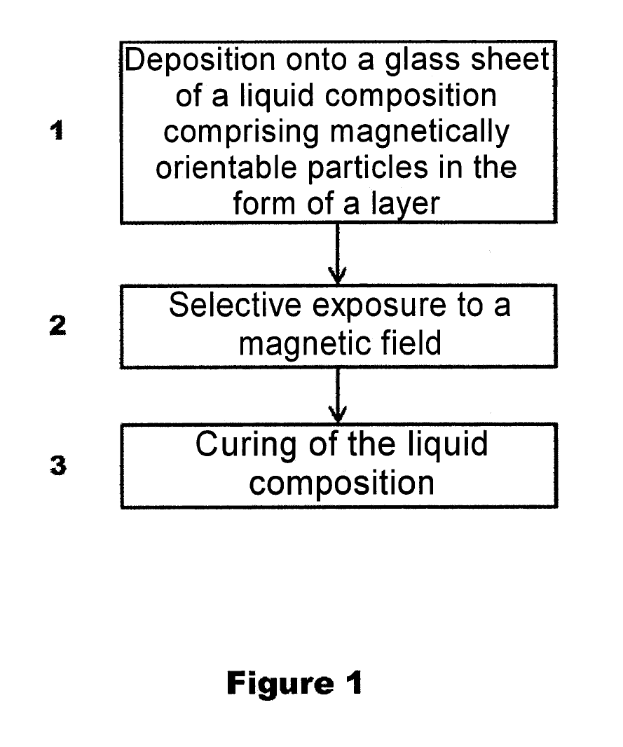

FIG. 1 schematically presents the steps of the method of the invention;

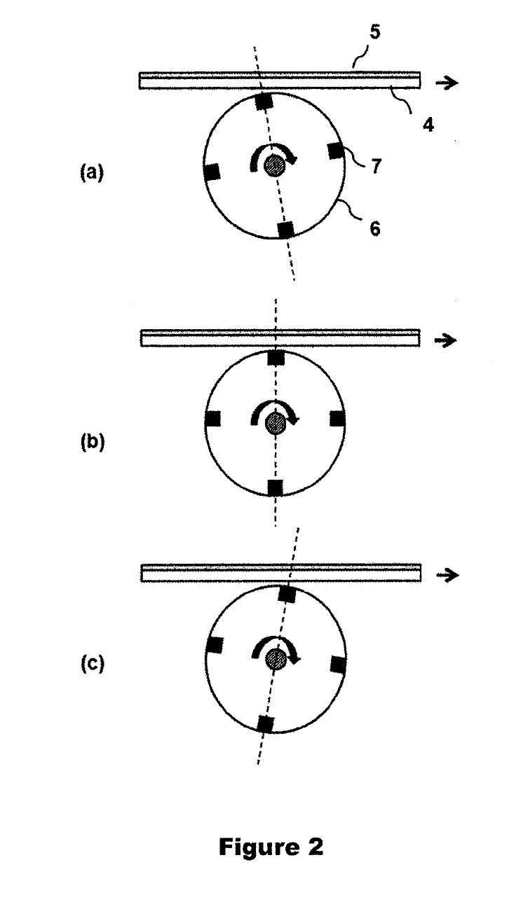

FIG. 2 schematically illustrates the step of selective exposure to a magnetic field of the glass sheet comprising the layer of liquid composition according to the invention (cross-sectional view);

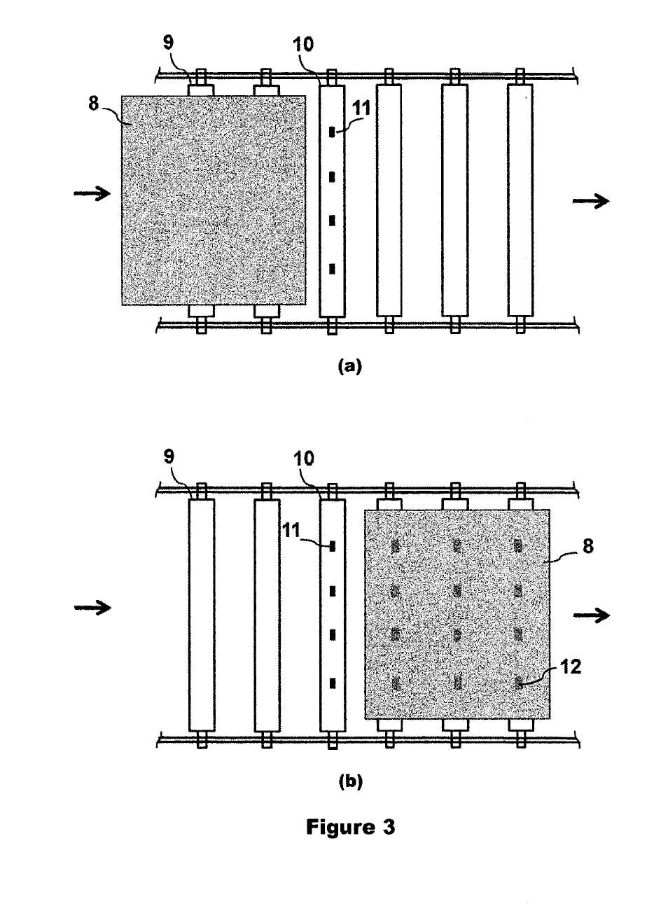

FIG. 3 schematically illustrates the step of selective exposure to a magnetic field of the glass sheet comprising the layer of liquid composition according to the invention and traveling on a roller conveyor (top view);

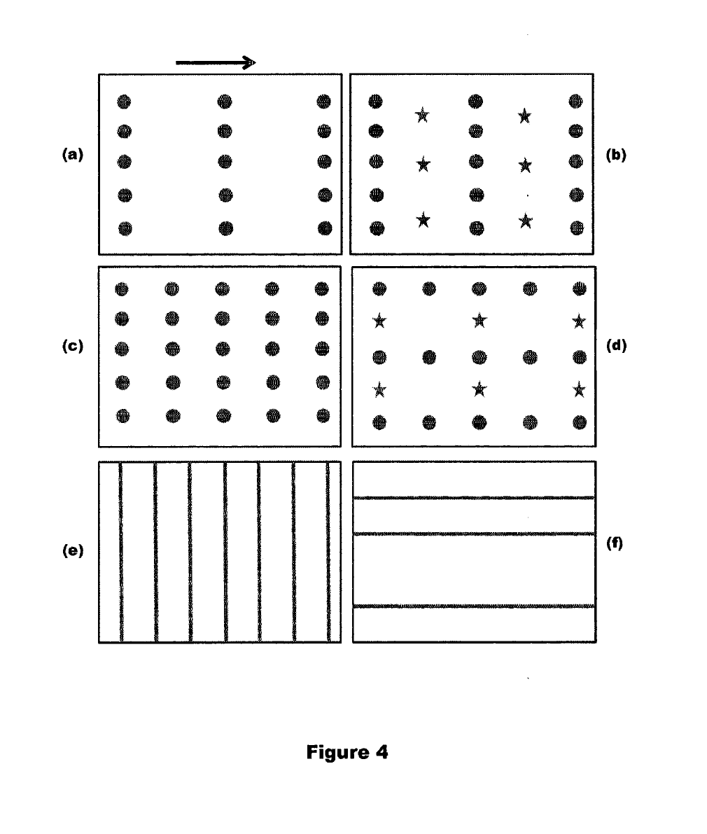

FIG. 4 schematically presents examples of arrangements of patterns magnetically induced in a layer deposited on a glass sheet that are capable of being obtained by the method of the invention; and

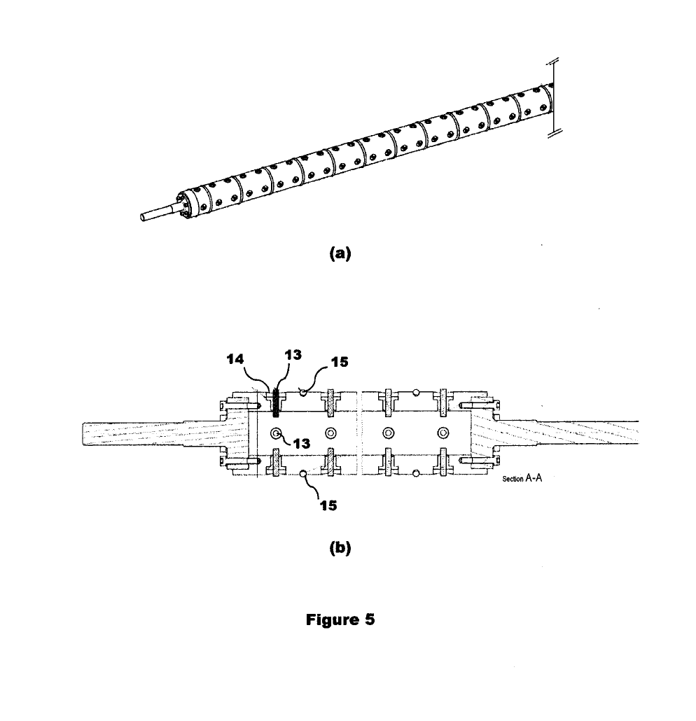

FIG. 5 presents (a) a diagram of the modified roller according to the invention and (b) a cross section through the length of said roller.

The sheet used in the method according to the invention is made of glass which can belong to various categories. The glass can thus be a glass of soda-lime type, a borate glass, a lead glass, a glass comprising one or more additives homogeneously distributed in its body, such as, for example, at least an inorganic colorant, an oxidizing compound, a viscosity regulator and/or an agent which facilitates melting. The glass of the invention may be a float glass, a drawn glass or a glass of “cast” type (laminated between rollers). It may be clear, extra-clear or body-tinted. The glass sheet may be thermally or chemically tempered. According to a preferred embodiment, the glass sheet is a float glass sheet. Very preferably, the glass sheet is a sheet of float glass of soda-lime type. The glass sheet may have a thickness that varies between 0.7 and 18 mm. The glass sheet may also have dimensions of greater than 1 m×1 m. It may, for example, have dimensions of 3.21 m×6 m or 3.21 m×5.50 m or 3.21 m×5.10 m or 3.21 m×4.50 m (referred to as “PLF” (jumbo size) glass sheet) or else, for example, 3.21 m×2.55 m or 3.21 m×2.25 m (referred to as “DLF” (production width size) glass sheet).

As illustrated in FIG. 1, the method of the invention comprises a step (1) of depositing, in the form of the layer, a liquid composition on at least one portion of the face of the glass sheet opposite that resting on the conveyor. The liquid composition may be deposited in the form of a layer by any means. The liquid composition according to the invention may, for example, be deposited on the glass sheet by curtain coating, roller coating or spray coating. The glass sheet, during step (1), may be immobile or else alternatively be moving, i.e. traveling either on a conveyor which will then continue to step (2), or on a belt. Preferably, the liquid composition is deposited by curtain coating, as this deposition technique makes it possible to apply a liquid layer onto a moving flat substrate at high speed (for example 50 meters per minute). In this case, the glass sheet preferably travels on two belts, the curtain of liquid composition being poured between them.

The weight of liquid composition (therefore just after step (2) but before the curing step 3) per unit of surface area of the glass sheet is preferably at least 50 g/m². The weight of liquid composition per unit of surface area is also preferably at most 180 g/m². Very preferably, the weight of liquid composition per unit of surface area is from 80 g/m² to 120 g/m².

According to the invention, the layer of liquid composition is deposited on at least one portion of one of the faces of the glass sheet. Preferably, the layer of liquid composition is deposited on practically the whole of the surface of one of the faces of the glass sheet. The expression “practically the whole of the surface” is understood to mean at least 90% of the surface.

According to the invention, the liquid composition comprises magnetically orientable particles. The magnetically orientable particles behave as miniature magnets. When they are placed in a magnetic field, such particles have a tendency to be oriented in the applied field so that their magnetic axis is aligned with the magnetic force lines of the field. According to the invention, the magnetically orientable particles may be of the type described in particular in U.S. Pat. No. 3,676,273; U.S. Pat. No. 4,838,648; WO 02/073250; EP 686 675 A1 or WO 2007/131833. Preferably, the magnetically orientable particles according to the invention are based on iron. According to the invention, the magnetically orientable particles may be flattened or in the form of flakes. The amount of magnetically orientable particles in the liquid composition (before curing) is preferably between 20% and 80% by weight of said liquid composition. Very preferably, the liquid composition comprises between 30% and 70% by weight of magnetically orientable particles.

According to the invention, the liquid composition comprises a liquid medium in which the magnetically orientable particles are in suspension. For example, the liquid composition according to the invention may be a paint, a lacquer, a varnish, an enamel or an ink. According to one particular embodiment, the liquid composition according to the invention comprises at least one component selected from acrylates, acrylics, acrylic resins, polyacrylate resins, urethanes, polyurethanes, polyamide polyols, melamine resins, polycarbonates, polyesters, polyolefins, polyamides, amino resins, epoxy resins, phenolic resins, silicone resins, PVC and PVB. Preferably, the liquid composition according to the invention comprises at least one component selected from acrylates, acrylics, acrylic resins, polyacrylate resins and melamine resins. Particularly preferably, the liquid composition according to the invention comprises at least one component selected from methacrylic resins, melamine-formaldehyde resins and epoxy resins.

According to the invention, the liquid composition may also advantageously comprise other components such as a curing agent, one or more solvents, a plasticizer, a dispersant, a catalyst, a photoinitiator, an adhesion promoter, a UV stabilizer, non-magnetic pigments, colorants, a flow agent, a wetting agent, an antifoaming agent, etc.

As illustrated in FIG. 1, the method according to the invention comprises a step (2) of selective exposure of the glass sheet comprising the layer of liquid composition to a magnetic field.

In the method of the invention, the glass sheet travels on a horizontal roller conveyor at least during the selective exposure step (2), in a direction perpendicular to the largest dimension of said rollers, the liquid composition being on the face opposite that resting on the conveyor. The roller conveyor according to the invention is a conventional roller conveyor, typically used in glass sheet production lines. It generally comprises several rollers positioned parallel to one another in the length and substantially at the same height, spaced apart by a distance that enables the glass sheet to lie at least on two rollers. Each roller may also advantageously conventionally comprise several “O-rings”, i.e. rubber seals over the circumference of the cross section of the roller, avoiding direct contact between the glass and the roller material. The rate of travel of the glass sheet on the conveyor preferably varies between 1 and 15 meters per minute. Very preferably, the rate of travel of the glass sheet on the conveyor preferably varies between 2 and 10 meters per minute.

According to the invention, the selective exposure step (2) is carried out by means of at least one roller of the conveyor, this roller comprising at least one element made of a material having permanent magnetization incorporated into the surface thereof, also referred to as “modified roller” in the remainder of the present text.

According to one embodiment, the modified roller is made from a cylindrical body made of non-magnetic material. For example, the cylindrical body of the roller is made of non-magnetic steel or of aluminum.

According to the invention, the elements made of a material having permanent magnetization, also referred to as permanent magnets in the remainder of the present text, may be selected from magnets of ferrite or ceramic type, magnets of Alnico (aluminum-nickel-cobalt) type, magnets of samarium-cobalt type or else magnets of neodymium-iron-boron type.

According to the invention, the expression “element made of a material having permanent magnetization incorporated into the surface of a roller of the conveyor” means that the element made of a material having permanent magnetization is incorporated into the cylindrical body of said roller, the outer surface thereof being located either (i) slightly below the outer surface of the roller, or (ii) substantially at the same level as the outer surface of the roller, being flush therewith without sticking out beyond it or else (iii) in the case where each roller of the conveyor (including the modified roller) comprises several O-rings, slightly below the outer surface of said O-rings or at the same level, without sticking out beyond it. The magnets may be positioned in the cylindrical body of the modified roller owing to small cavities present in this cylindrical body. Advantageously, the “depth” of the magnet in its cavity may be adapted in order to modify the distance between the magnet and the layer deposited on the glass sheet, which makes it possible to slightly modify the optical rendering of the magnetically induced pattern when the glass thickness remains constant or else to retain an identical optical rendering when thicker glass sheets are passed over the conveyor.

According to the invention, the modified conveyor roller may comprise a single permanent magnet.

Advantageously, in order to produce more complex patterns in the layer deposited on the glass sheet, the modified conveyor roller comprises several permanent magnets. According to this embodiment, the permanent magnets may be identical, in terms of shape, size and strength. Alternatively, the permanent magnets may be different, in terms of shape, size and/or strength. The shape and size of the permanent magnets according to the invention will respectively determine the shape and size of the pattern induced in the layer by each of these elements and therefore the appearance of the overall pattern. The strength of the permanent magnets according to the invention will determine the optical/esthetic rendering of the magnetically induced pattern. A stronger magnet will give a more pronounced pattern, with an impression of more pronounced depth, sometimes also of darker color. Still according to this embodiment, the permanent magnets may be placed at identical distances from the glass sheet and therefore from the layer or, alternatively, at different distances, by varying the “depth” of the magnets incorporated into the surface of the modified roller.

The modified roller, comprising at least one magnet incorporated into the surface thereof, makes it possible to produce magnetic field lines in the vicinity of the sheet traveling on the conveyor. Advantageously according to the invention, the exposure to the magnetic field lines takes place very efficiently since the glass sheet, and therefore the layer, is exposed to the magnetic field for a sufficient time, even in the case of a high rate of travel of the glass sheet on the conveyor generally required by an in-line process. Indeed, this is illustrated in FIG. 2 (cross-sectional view parallel to the direction of travel of the glass sheet), which shows a glass sheet (4) covered by a layer of liquid composition (5) after the deposition step (1) traveling (in the direction indicated by the arrow) on top of a modified roller (6) according to the invention in which four magnets (7) have been incorporated in the surface of said roller, placed around its circumference at 90° from one another. This figure shows, in (a), the approach movement of one of the magnets of the roller toward the glass sheet, already generating field lines in the vicinity of the sheet, in (b) the position of said magnet facing the glass sheet generating maximum magnetization, and in (c) the receding movement of the magnet, still generating field lines in the vicinity of the sheet.

According to the invention, the modified roller may comprise one or more “discrete” and/or “continuous” magnets.

A “discrete” magnet is understood to mean a magnet for which all the dimensions are significantly smaller than the dimensions of the modified roller (length and circumference of its cross section). When one such discrete magnet is present on the modified roller, the pattern that it induces (as a function of its size and of its shape) is then repeated in the layer regularly in the direction of movement of the sheet, with a spacing that corresponds to the circumference of the cross section of the modified roller. If the roller comprises more than one permanent magnet aligned in the circumference of a cross section of the roller and evenly spaced out, the pattern induced is then repeated in the direction of movement of the sheet, with a spacing that corresponds to the circumference of the cross section of the modified roller divided by the number of magnets present around this circumference.

FIG. 3 illustrates the process of step (2) according to the invention. In FIG. 3 (a), the glass sheet (8) covered by a layer of liquid composition comprising magnetically orientable particles travels, in the direction of the arrows, on a roller conveyor (9) and approaches a modified roller (10) according to the invention comprising four permanent magnets (ii) incorporated into the surface thereof and aligned along the length thereof. After having traveled over the modified roller (FIG. 3 (b)), magnetically induced patterns (12), corresponding to the shape and the size of the magnets, are created in the layer of liquid composition in the form of lines of four patterns spaced apart by a distance corresponding to the circumference of the cross section of the roller.

FIGS. 4 (a) to (d) schematically present examples of arrangements of magnetically induced patterns in a layer deposited on a glass sheet according to the invention owing to discrete magnets incorporated into a roller of the conveyor.

A “continuous” magnet is understood to mean a magnet that is continuous over one of the dimensions (length and circumference) of the roller, either (i) in the length of the roller, thus creating repetitive lines perpendicular to the movement of the sheet and spaced apart by a distance equal to the circumference of the roller (see FIG. 4 (e)), or (ii) in the circumference of the cross section of the roller, thus creating a line parallel to the movement of the sheet having a thickness that varies as a function of the thickness of the continuous magnet in the circumference. Several continuous magnets, in the length and/or in the circumference (see FIG. 4 (f)) of the modified roller, may be present. If several continuous magnets in the length and in the circumference are present on the modified roller, it is then possible to create a general pattern corresponding to a grid.

Advantageously, in order to produce more complex patterns in the layer deposited on the glass sheet, the conveyor may comprise several, identical or different, modified rollers. This embodiment is of course compatible, for each roller, with all the embodiments disclosed above that correspond to the modified roller.

As illustrated in FIG. 1, the method according to the invention comprises a step (3) of curing the liquid composition. This step makes it possible to change from a wet liquid layer to a hard and dry layer. Hence it makes it possible to set the oriented particles and therefore to fix the patterns created in the layer by the selective magnetization step. The curing step according to the invention may be carried out by drying the composition (for example, evaporation of solvents) and/or by crosslinking. Crosslinking is understood to mean a step that involves chemical polymerization reactions and the formation of a three-dimensional polymer network. Curing by crosslinking according to this embodiment may be obtained by heating (typically at temperatures of the order of 100° C. to 200° C.) and/or by exposure to radiation (for example UV or infrared radiation). In the case of the use of crosslinking as a method of curing the layer of the invention, the liquid composition advantageously comprises a curing agent/catalyst.

The thickness of the layer according to the invention, once cured in step 3, is at least 5 microns and at most 150 microns. Preferably, the thickness of the layer according to the invention, once cured in step 3, is at least 20 microns and at most 120 microns.

According to one particular embodiment, the method of the invention comprises an additional step of treating the glass sheet with an adhesion primer before the deposition (1) of the layer of liquid composition. This adhesion primer may be deposited by any manner known in the art. The adhesion primer enables a better adhesion of the layer, once cured, to the glass. Silane is a compound commonly used for such a treatment.

Preferably, the layer according to the invention is in direct contact with the glass, that is to say that no other layer is present between the glass and the layer comprising the magnetically orientable particles. Treatment with a silane-type adhesion primer does not constitute another layer within the meaning of the present embodiment. Therefore, this embodiment is not incompatible with a silane treatment.

According to another particular embodiment, the method of the invention comprises an additional step of cleaning the glass sheet, before the deposition of the layer of liquid composition, and at least the face intended to receive the liquid composition. This cleaning may be carried out, for example, with water or an aqueous solution containing a detergent.

According to yet another particular embodiment, the method of the invention comprises an additional step of polishing the glass sheet with the aid of a polishing agent, before the deposition (i) of the layer of liquid composition, and at least on the face intended to receive the liquid composition. An example of a polishing agent that may be used is a powder comprising cerium oxide, CeO₂.

According to one particular embodiment, the method of the invention comprises an additional step, after the curing step (3), which corresponds to the deposition of at least one additional layer, then covering the cured layer. It may be, for example, a layer of mechanical protection, an antireflection layer, a layer for preventing finger marks, etc.

The examples which follow illustrate the invention without the intention of limiting its coverage in any way.

### EXAMPLE

### In Accordance with the Invention

A 3.21 m×2.25 m (DLF, or production width size) sheet of clear glass having a thickness of 4 mm was placed on a roller conveyor. Along its journey on the conveyor, it first underwent polishing with a powder comprising cerium oxide in order to clean its surface. It then underwent a silane treatment.

It was then passed under a curtain coater with a speed of around 50 meters per minute in order to deposit the liquid composition according to the invention thereon. The liquid composition applied is a paint of light gray color comprising a Glassorex clearcoat (from the company Fenzi) based on resins of the methacrylic melamine-formaldehyde and epoxy type, and comprising 50% by weight of FERRICON® 160 pigments from the company Eckart. The amount of liquid composition applied to the glass sheet is 100 g/m².

Next, the glass sheet was slowed down to a substantially constant speed of the order of 4 meters per minute and at that point it passed over a modified conveyor roller according to the invention. The roller, made of aluminum, was modified by incorporation in the surface thereof (the outer surface of the magnets coming to slightly below the surface of the roller) of 216 magnets, distributed along its length (54 magnets equidistant by 5 cm over one row) and along its circumference (each time 4 magnets, at 90° from one another). The modified roller used is depicted in FIG. 5(a) and a cross section of this roller along the length is shown schematically in FIG. 5(b). Each of the magnets (13) is a neodymium-iron-boron magnet (Supermagnete S-05-25-N), of cylindrical shape, the circular cross section of which has a diameter of 5 mm and the length of which is 25 mm. Each magnet was positioned in the roller, in cavities (14), so that its length is perpendicular to the length of the roller and so that one of its circular ends is positioned toward the outside of the surface of the roller, slightly above this surface but below the outer surface of the O-rings (15) used.

The glass sheet was thus selectively exposed to a field creating, in the liquid composition, patterns of three-dimensional appearance, of darker color, that are repetitive and of circular shape.

Finally, it passed into an oven heated at 165-170° C. for a few minutes and the liquid composition then cured/crosslinked, thus setting the patterns created in the preceding step.

1. A method for producing a magnetically induced pattern in a layer deposited on a glass sheet, the method comprising:
depositing a liquid composition in the form of a layer on at least one portion of one face of the glass sheet, wherein the liquid composition comprises magnetically orientable particles;
selectively exposing the glass sheet comprising the layer of liquid composition to a magnetic field during which the glass sheet travels on a horizontal roller conveyor, in a direction perpendicular to a largest dimension of the roller, wherein the liquid composition is on a face opposite to a face resting on the conveyor; and then
curing the liquid composition;
wherein at least one roller of the conveyor comprises an element made of a material having permanent magnetization incorporated into a surface thereof, so as to produce magnetic field lines in a vicinity of the sheet traveling on the conveyor.

2. The method of claim 1, wherein a rate of travel of the glass sheet on the conveyor at the moment of the selective exposing is from 1 to 15 meters per minute.

3. The method of claim 1, wherein a rate of travel of the glass sheet on the conveyor at the moment of the selective exposing is from 2 to 10 meters per minute.

4. The method of claim 1, wherein an amount of the magnetically orientable particles in the liquid composition before curing is between 20% and 80% by weight of the liquid composition.

5. The method of claim 1, wherein an amount of the magnetically orientable particles in the liquid composition before curing is between 30% and 70% by weight of the liquid composition.

6. The method of claim 1, wherein a thickness of the layer, after the curing, is at least 5 microns and at most 150 microns.

7. The method of claim 1, further comprising treating the glass sheet with an adhesion primer before the deposition of the layer of liquid composition.

8. The method of claim 1, wherein the liquid composition is deposited by curtain coating.

9. The method of claim 1, wherein a weight of the liquid composition per unit of surface area of the glass sheet before the curing is at least 50 g/m².

10. The method of claim 1, wherein a weight of the liquid composition per unit of surface area of the glass sheet before the curing is from 80 g/m² to 120 g/m².

11. The method of claim 1, wherein the glass sheet is a sheet of float glass of soda-lime type.
